(19) United States
(12) Patent Application Publication
(10) Pub. No.: US 2009/0201445 A1
(43) Pub. Date: Aug. 13, 2009

(54) LIQUID CRYSTAL DISPLAY DEVICE

(75) Inventor: Nobuyuki Koganezawa, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd

(21) Appl. No.: 12/366,027

(22) Filed: Feb. 5, 2009

(30) Foreign Application Priority Data
Feb. 7, 2008 (JP) JP2008-27377

(51) Int. Cl. G02F 1/1347; G02F 1/13357

(52) U.S. Cl. 349/74; 349/69

(57) ABSTRACT

The invention intends to reduce the luminance non-uniformity of a screen in a liquid crystal display device capable of displaying both an image on a liquid crystal display panel and a display object while switching between them. A liquid crystal display device includes a liquid crystal shutter disposed at the back surface of a liquid crystal display panel and a display object disposed at the back surface of the liquid crystal shutter. The display object can be observed when the liquid crystal shutter is opened while an image on the liquid crystal display panel is displayed when the liquid crystal shutter is closed. The distribution of output light from an LED as a light source has peaks in two directions. The use of the LED makes it possible to uniform the luminance of a display screen.

### CROSS-REFERENCE TO RELATED APPLICATION

The present application claims priority from Japanese application JP2008-27377 filed on Feb. 7, 2007, the content of which is hereby incorporated by reference into this application.

### BACKGROUND OF THE INVENTION

1. Field of the Invention

The present invention relates to a liquid crystal display device and particularly to a liquid crystal display device capable of displaying an image formed on a liquid crystal display panel and a display object present at the back surface of the liquid crystal display panel while switching between them.

2. Description of the Related Art

Demand for liquid crystal display devices is expanding from computer displays and mobile phone terminals to TV sets and the like because display devices can be made thin and do not increase in weight. Since a liquid crystal display panel itself does not emit light, a backlight is disposed at the back surface of the liquid crystal display panel in order to display images, and images are formed by controlling the light from the backlight for each pixel.

The liquid crystal display device is applicable to various display devices because it can be made thin. In a gaming display, there is a request to display a specific image using the same liquid crystal screen in addition to an image displayed by liquid crystal. The display can be achieved by disposing a liquid crystal shutter at a backlight portion and using the liquid crystal shutter as a diffusing plate when a usual liquid crystal screen is displayed.

On the other hand, when displaying not an image formed on a liquid crystal panel but a specific image, the entire surface of the liquid crystal display panel is set to a transmissive state, and at the same time the liquid crystal shutter is set to the transmissive state by applying voltage to the liquid crystal shutter. With this operation, the specific image placed at the back surface of the liquid crystal shutter can be visually recognized. In this case, a light source is disposed at the side of the liquid crystal shutter or the like so as not to prevent the visual recognition of the specific image at the back surface.

Such a technique is disclosed in JP-A-2007-7315, for example.

In the related art disclosed in JP-A-2007-7315, a CCFL (cold cathode fluorescent lamp) disposed laterally outside the liquid crystal shutter or the like is used as the light source of a backlight. In this configuration, the luminance non-uniformity of the screen becomes a problem.

A usual liquid crystal display device of the side light type requires various optical components in order to make light uniformly incident on the liquid crystal display panel from a CCFL disposed at the side. FIG. 17 is a cross sectional view of a usual liquid crystal display device having a backlight. In FIG. 17, a mold accommodating a liquid crystal display panel, a driving IC, and the like are omitted. In FIG. 17, the liquid crystal display device includes a liquid crystal display panel and a backlight.

The liquid crystal display panel includes a TFT substrate 11 formed with pixel electrodes, thin film transistors (TFTs), scanning lines, data signal lines, and the like and a counter substrate 12 formed with a color filter and the like. Liquid crystal is interposed between the TFT substrate 11 and the counter substrate 12. The orientation of the liquid crystal is changed in accordance with a data signal applied to the pixel electrodes and the like, and transmitted light is controlled for each pixel, whereby an image is formed. The light incident on the liquid crystal display panel must be polarized light because liquid crystal can be controlled with respect to polarized light. Therefore, a lower polarizer 14 is bonded to the TFT substrate 11 while an upper polarizer 13 is bonded above the counter substrate 12.

In FIG. 17, the backlight includes a light source 30, a light guide plate 21, and various optical sheets. The light source 30 is disposed at the side of the light guide plate 21. The backlight of the light guide plate type is used as described-above because the thickness of the display device is made thin. A CCFL 30 or the like is used for the light source 30.

The light guide plate 21 acts to direct light incident from the side toward a liquid crystal display panel direction. A reflective sheet 26 is disposed under the light guide plate 21 and reflects light from the light source 30 to a liquid crystal display panel side. Light output from the light guide plate 21 to the liquid crystal display panel direction has non-uniformity in light intensity. A lower diffusing sheet 22 serves to uniform light output from the light guide plate 21. A lower prism sheet 23 in FIG. 17 serves to direct light spreading in a direction perpendicular to the paper surface among the light from the light guide plate 21 toward the normal line direction of the liquid crystal display panel with a micro prism. An upper prism sheet 24 serves to focus light spreading in a direction parallel to the paper surface among the light from the light guide plate 21 into the normal line direction of the liquid crystal display panel with a micro prism. An upper diffusing sheet 25 serves to decrease moire caused by the interference between the light which is output from the prism sheet and periodically changes in intensity and the periodical change in transmittance ratio due to the scanning line, data signal line, or the like of the liquid crystal display panel by diffusing the light from the prism sheet.

As described above, the various optical components disposed at the backlight are used for the uniformity of the light incident on the liquid crystal display panel in the usual liquid crystal display device. However, in the liquid crystal display device of the type of displaying a specific image 40 disposed at the back surface of the liquid crystal display panel, the light guide plate 21, the diffusing sheet, and the like present at the backlight of the conventional liquid crystal display device cannot be used. This is particularly because the luminance non-uniformity of the screen occurs. Specifically, there arises a problem that the luminance is higher at the periphery of the screen while the luminance is lower in the vicinity of the center of the screen.

The invention intends to solve the above-described problem, and it is an object of the invention to provide a configuration which uniforms the luminance of a screen in both cases where the image of the liquid crystal display panel is displayed and the specific image 40 at the back surface is displayed in the liquid crystal display device capable of displaying the specific image 40 present at the back surface of the liquid crystal display panel.

### SUMMARY OF THE INVENTION

In a liquid crystal display device having a liquid crystal shutter disposed at the back surface of a liquid crystal display panel and a display object disposed at the back surface of the liquid crystal shutter and capable of alternately displaying an image formed on the liquid crystal display panel and the display object disposed at the back surface of the liquid crystal shutter, an LED having the peaks of output light in two directions is disposed at the side as a light source.

### BRIEF DESCRIPTION OF THE DRAWINGS

FIG. 1 is a cross sectional view of a liquid crystal display device showing a first embodiment;

FIG. 2 shows the distribution of output light of an LED used in FIG. 1;

FIG. 3A is a schematic cross sectional view of a liquid crystal shutter under no application of voltage;

FIG. 3B is a schematic cross sectional view of a liquid crystal shutter under the application of voltage;

FIG. 4 is a cross sectional view of a liquid crystal display device in the related art using a CCFL as a light source;

FIG. 5 shows the distribution of the output light of a CCFL;

FIG. 6 is a table showing the relationship between a backlight structure and a luminance distribution;

FIG. 7 shows the measurement position for luminance;

FIG. 8 is a table showing backlight specifications and the numerical values of luminance distribution;

FIG. 9 is a graph showing the backlight structure and the luminance distribution;

FIG. 10 is a schematic cross sectional view showing the position of an LED;

FIG. 11 is a table showing the position of an LED and the luminance distribution;

FIG. 12 is a graph showing the position of an LED and the luminance distribution;

FIG. 13 is a cross sectional view of a liquid crystal display device showing a second embodiment;

FIG. 14 shows the distribution of the output light of an LED used in the second embodiment;

FIG. 15 is a cross sectional view of a liquid crystal display device showing a third embodiment;

FIG. 16 shows the distribution of output light from a light source of the third embodiment; and

FIG. 17 is a cross sectional view of a conventional liquid crystal display device of a side light type.

### DESCRIPTION OF THE PREFERRED EMBODIMENTS

Specific means are as follows.

(1) A liquid crystal display device includes a liquid crystal display panel, a liquid crystal shutter disposed at the back surface of the liquid crystal display panel, a display object disposed at the back surface of the liquid crystal shutter, and a light source disposed outside a display surface of the liquid crystal display panel, at the back surface of the liquid crystal shutter, and at the front surface of the display object, in which the liquid crystal shutter is in a white-opaque light scattering mode when an image formed on the liquid crystal display panel is displayed, the liquid crystal shutter is in a light transmitting mode when the display object is displayed, the light source is formed of an LED, and peaks are present in two directions in the distribution of output light from the LED.

The display object may be a specific picture or image or a display device capable of displaying an image, or may be a specific object (ornament) such as a doll.

(2) The liquid crystal display device according to (1), in which the LED is disposed at both sides.

(3) A liquid crystal display device includes a liquid crystal display panel, a liquid crystal shutter disposed at the back surface of the liquid crystal display panel, a display object disposed at the back surface of the liquid crystal shutter, and a light source disposed outside a display surface of the liquid crystal display panel, at the back surface of the liquid crystal shutter, and at the front surface of the display object, in which the liquid crystal shutter is in a white-opaque light scattering mode when an image formed on the liquid crystal display panel is displayed, the liquid crystal shutter is in a light transmitting mode when the display object is displayed, the light source is formed of paired two LEDs, and peaks are present in two directions in output light from the paired two LEDs.

(4) The liquid crystal display device according to (3), in which the normal lines of the paired two LEDs are not in parallel with each other.

(5) The liquid crystal display device according to (3), in which the paired two LEDs are disposed at both sides.

(6) A liquid crystal display device includes a liquid crystal display panel, a liquid crystal shutter disposed at the back surface of the liquid crystal display panel, a display object disposed at the back surface of the liquid crystal shutter, and a light source disposed outside a display surface of the liquid crystal display panel, at the back surface of the liquid crystal shutter, and at the front surface of the display object, in which the liquid crystal shutter is in a white-opaque light scattering mode when an image formed on the liquid crystal display panel is displayed, the liquid crystal shutter is in a light transmitting mode when the display object is displayed, the light source is formed of an LED, a lens is disposed on an output surface of light from the LED, and peaks are present in two directions in the distribution of output light from the lens.

(7) The liquid crystal display device according to (6), in which the LED is disposed at both sides.

(8) A liquid crystal display device includes a liquid crystal display panel, a liquid crystal shutter disposed at the back surface of the liquid crystal display panel, a display object disposed at the back surface of the liquid crystal shutter, and a light source disposed outside a display surface of the liquid crystal display panel, at the back surface of the liquid crystal shutter, and at the front surface of the display object, in which the liquid crystal shutter is in a white-opaque light scattering mode when an image formed on the liquid crystal display panel is displayed, the liquid crystal shutter is in a light transmitting mode when the display object is displayed, the light source is formed of an LED, the LED is accommodated in a U-shaped region surrounded by a sidewall in a direction parallel to the normal line of the liquid crystal display panel and upper and lower walls in a direction substantially orthogonal to the sidewall in cross section, the center of the LED does not coincide with the center of the sidewall, and peaks are present in two directions in the distribution of output light from the LED.

(9) The liquid crystal display device according to (8), in which the shift amount between the center of the LED and the center of the sidewall is 2 mm or more.

According to a liquid crystal display device to which the invention is directed, it is possible to uniform the display luminance of a display image of a liquid crystal display panel or a display object disposed at the back surface of a liquid crystal shutter by using an LED with a directional characteristic having the peaks of output light in two directions as a light source although optical components such as a light guide plate, a diffusing sheet, and a prism cannot be used as a backlight.

According to another aspect of the invention, it is possible to uniform the display luminance of a display image of a liquid crystal display panel or a display object disposed at the back surface of a liquid crystal shutter because paired two LEDs are used as a light source disposed at the side to differentiate the normal line directions of the two LEDs from each other so that output light has peaks in two direction.

According to still another aspect of the invention, it is possible to uniform the display luminance of a display image of a liquid crystal display panel or a display object disposed at the back surface of a liquid crystal shutter because an LED is used as a light source disposed at the side, and a lens is disposed on an output surface of light from the LED so that output light from the lens has peaks in two directions.

The contents of the invention will be disclosed in detail in accordance with embodiments.

### First Embodiment

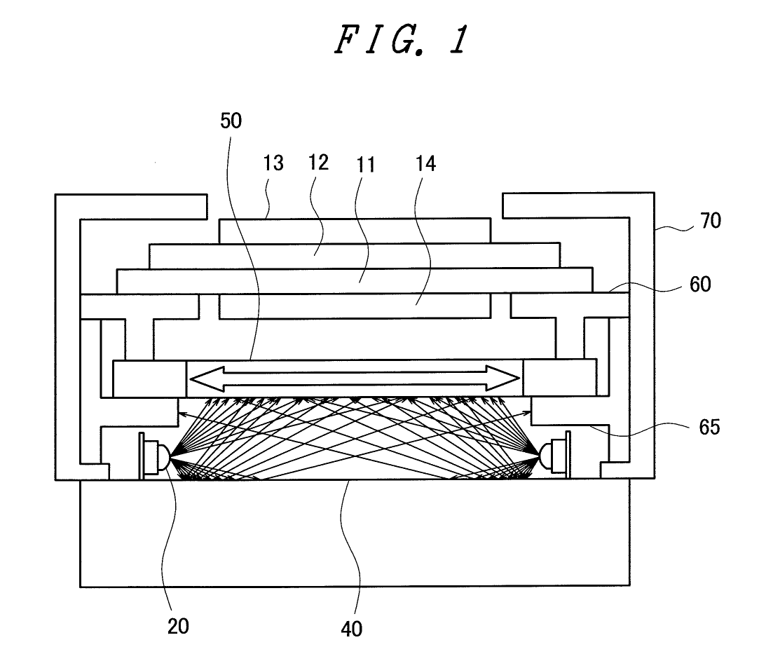

FIG. 1 is a cross sectional view showing a first embodiment of the invention. In FIG. 1, a liquid crystal display panel is mounted on an upper mold 60. The liquid crystal display panel includes a TFT substrate 11 formed with pixel electrodes, TFTs, and the like and a counter substrate 12 formed with a color filter and the like. Liquid crystal is interposed between the TFT substrate 11 and the counter substrate 12. A lower polarizer 14 and an upper polarizer 13 are bonded below the TFT substrate 11 and above the counter substrate 12, respectively.

The TFT substrate 11 is formed to be slightly larger than the counter substrate 12. A terminal part 111 for supplying power, a signal, and the like to the liquid crystal display panel is formed on the portion where only the TFT substrate 11 exists. The terminal part 111 is connected to a not-illustrated, flexible wiring substrate to be connected to an external circuit.

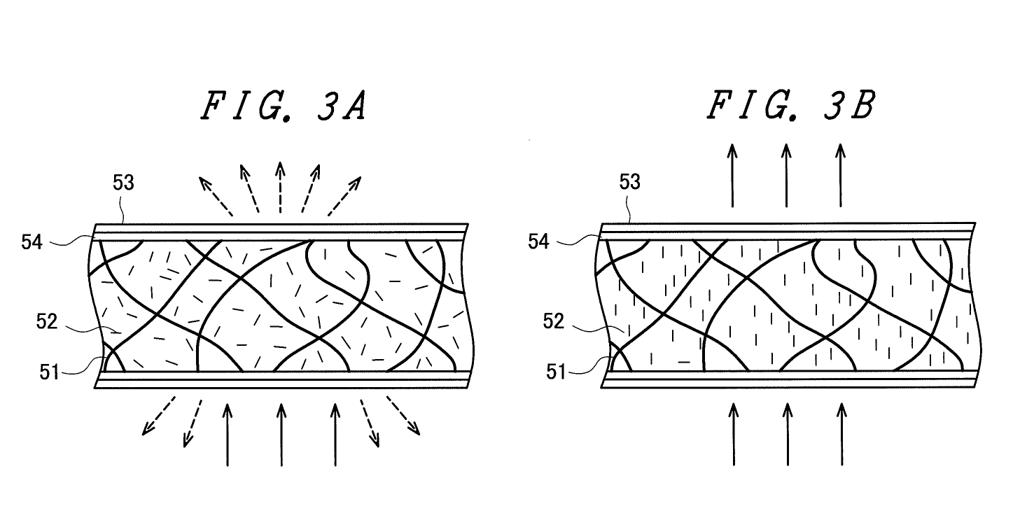

A liquid crystal shutter 50 is mounted on a lower mold at the back surface of the liquid crystal display panel. FIGS. 3A and 3B show a schematic configuration of the liquid crystal shutter 50. The liquid crystal shutter 50 allows light to pass therethrough upon application of voltage and scatters light with no application of voltage. FIG. 3A is a schematic cross sectional view of the liquid crystal shutter 50 under no application of voltage. In FIG. 3A, liquid crystal is enclosed between plastic substrates 53. Between the plastic substrates 53, high polymer molecules 51 are configured in a network form, in which liquid crystal molecules 52 are randomly oriented. In the state of FIG. 3A, the randomly oriented liquid crystal molecules 52 scatter light, whereby the liquid crystal shutter 50 is in a white opaque state. The liquid crystal shutter 50 in this state acts as a kind of diffusing plate. Transparent electrodes 54 such as of ITO are each formed inside the plastic substrates 53.

In the state of FIG. 3A, a display object (referred to as a specific image or specific object) 40 disposed at the back surface of the liquid crystal display panel cannot be visually recognized from the front thereof. Accordingly, the liquid crystal display device in FIG. 1 serves as a usual liquid crystal display device in the state where voltage is not applied to the liquid crystal shutter 50, and an image formed on the liquid crystal display panel is visually recognized.

FIG. 3B shows the state where voltage is applied to the transparent electrodes 54 each formed inside the plastic substrates 53. When voltage is applied between the upper and lower transparent electrodes 54, the liquid crystal molecules 52 are aligned in the vertical direction as shown in FIG. 3B, allowing light passing through the liquid crystal shutter 50.

In the state where light passes through the liquid crystal shutter 50 with voltage applied to the liquid crystal shutter 50, all pixels of the liquid crystal display panel in FIG. 1 are in a transmissive state, that is, in a white display state. Therefore, the specific image 40 disposed at the back surface of the liquid crystal shutter 50 is visually recognized because the liquid crystal display panel and the liquid crystal shutter 50 are both in the transmissive state. In this case, the specific image 40 disposed at the back surface of the liquid crystal shutter 50 may be the drum of a slot machine game machine or a three-dimensional object. Hereinafter, the specific image 40 includes a three-dimensional object.

The turning ON and OFF of the liquid crystal shutter 50 shown in FIG. 3 can be switched in the order of msec (millisecond). Accordingly, the image formed by the liquid crystal display panel and the specific image 40 present at the back surface of the liquid crystal shutter 50 can be switched at high speed in the order of msec (millisecond). The liquid crystal shutter 50 is sometimes sandwiched between transparent plastic reinforcing plates for reinforcement in order to dispose the liquid crystal shutter 50 in a mold.

In FIG. 1, LEDs (Light Emitting Diodes) 20 as a light source are disposed at both sides in the lower mold 65. Further, the LEDs 20 are arranged in plural in the vertical direction of the paper surface. In FIG. 1, non-uniformity tends to occur in light incident on the liquid crystal display panel because optical components are not present between the LEDs 20 and the liquid crystal display panel unlike a usual backlight. The invention intends to set the light incident on the liquid crystal display panel uniform by using the LED 20 which has a specific directional characteristic as a light source without using a light guide plate, an optical sheet, and the like.

The upper mold 60 on which the liquid crystal display panel is mounted, and the lower mold 65 on which the liquid crystal shutter 50 is mounted and which accommodates the LEDs 20 at its side parts are accommodated in a frame 70, thereby forming the liquid crystal display device according to the embodiment.

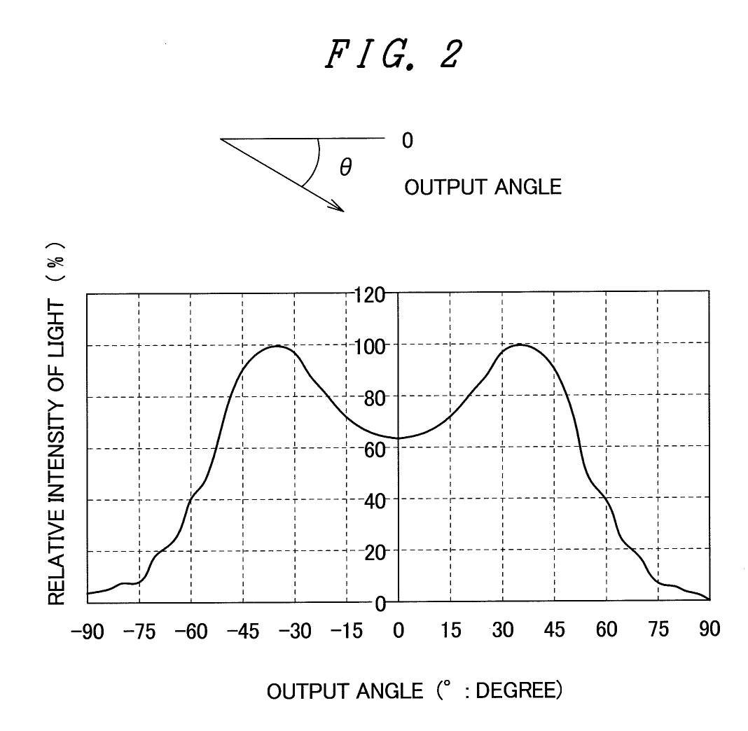

FIG. 2 shows the luminance distribution of the LED 20 used in the embodiment. In FIG. 2, the abscissa axis represents the output angle (θ) with the normal line direction of the LED 20, that is, a direction parallel to the liquid crystal display panel shown in FIG. 1 as zero degree. The output angle means a radiation angle (θ). The ordinate axis in FIG. 2 represents the relative intensity of light output from the LED 20. In the LED 20 used in the embodiment, as shown in FIG. 2, the intensity of the light output from the LED 20 reaches a maximum not in the normal line direction of the LED 20 but at about 35 degree from the normal line direction of the LED 20.

As described above, by allowing the output light from the LED 20 to have its peak not in the normal line direction but in the direction shifted by a specific angle upward and downward, the light intensity distribution can be optimized in both cases where the liquid crystal display device displays an image from the liquid crystal display panel like a usual liquid crystal display device or where the liquid crystal display panel merely allows light to pass therethrough and displays the specific image 40 disposed at the back surface.

That is, when the output light from the LED 20 is distributed most intensely in the normal line direction of the LED 20, the light use efficiency is lowered because another LED 20 facing to the LED 20 is mostly irradiated with the light. A usual backlight can direct also the light outputting in the normal line direction of the LED 20 toward the liquid crystal display panel direction by appropriately reflecting and diffusing the light because of the presence of a light guide plate 21. In the embodiment, however, uniform light is obtained by changing the directional characteristic of the output light of the LED 20 because of the absence of the light guide plate 21.

In the embodiment, although the maximum value of the output light of the LED 20 is set at +35 degree and −35 degree, an appropriate angle sometimes varies depending on the size of a space under the liquid crystal shutter 50. Further, the directional characteristic of the output light of the LED 20 is sometimes changed depending on whether the position where the LED 20 is located is close to the specific image 40 at the back surface or close to the liquid crystal shutter 50. In such a case, the directional characteristic of the LED 20 due to angle is sometimes set asymmetrically. The directional characteristic of the output light from the LED 20 can be changed by changing the shape of a mirror surface disposed at the back surface of an LED 20 chip in the LED 20.

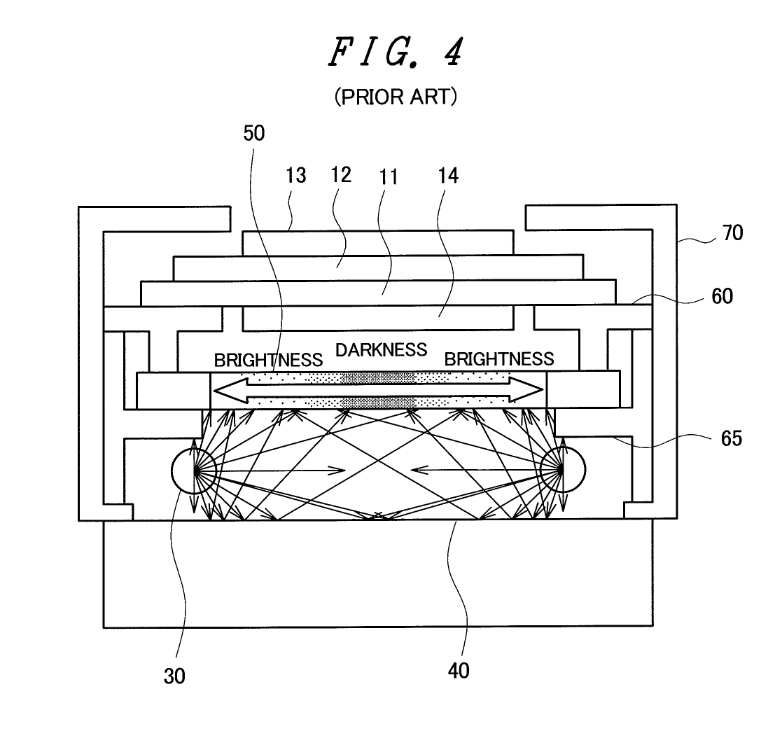

FIG. 4 shows a liquid crystal display device as a comparative example with respect to the embodiment. In FIG. 4, the liquid crystal display panel, the liquid crystal shutter 50, the upper mold 60, the lower mold 65, and the like are similar to those in FIG. 1. FIG. 4 is different from FIG. 1 in that CCFLs 30 are used as a light source instead of the LEDs 20. The use of the CCFL 30 as a light source involves the following problem.

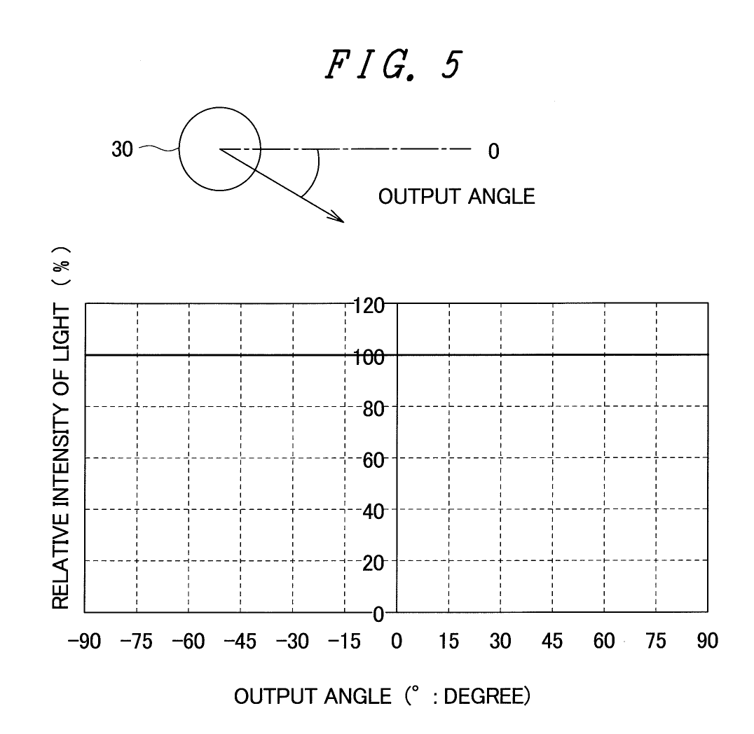

FIG. 5 shows the distribution of light output from the CCFL 30. In FIG. 5, the abscissa axis represents the output angle while the ordinate axis represents the relative intensity of output light. In FIG. 5, the output intensity from the CCFL 30 is constant irrespective of the output angle (θ). That is, the CCFL 30 outputs light radially and uniformly. The use of the CCFL 30 for the liquid crystal display device shown in FIG. 4 as a light source causes a phenomenon that the vicinity of the CCFL 30, that is, only at the periphery of the screen of the liquid crystal display panel is bright.

That is, as shown in FIG. 4, the luminance flux density shown by the arrow is high in the vicinity of the CCFL 30 while the luminance flux density is low near the center of the liquid crystal display device. The light incident on the vicinity of the CCFL 30 reflects diffusely in that portion, whereby a portion exposed to much luminance flux from the CCFL 30 is visually recognized as being brighter.

On the other hand, the LED 20 used as a light source in the embodiment has the directional characteristic and has peaks in both the plus and minus directions in terms of angle, and can have the directional characteristic in accordance with the space shape at the back surface of the liquid crystal shutter 50. Therefore, a screen with a uniform luminance can be obtained without using the light guide plate 21 or the like according to the embodiment.

In the above description, the LED 20 has been described as being disposed at both sides of the liquid crystal display device. However, a similar theory is applicable to the case where the LED 20 is disposed only at one side. When the LED 20 is disposed only at one side, the position or direction of two peaks in the output intensity of the LED 20 may be changed.

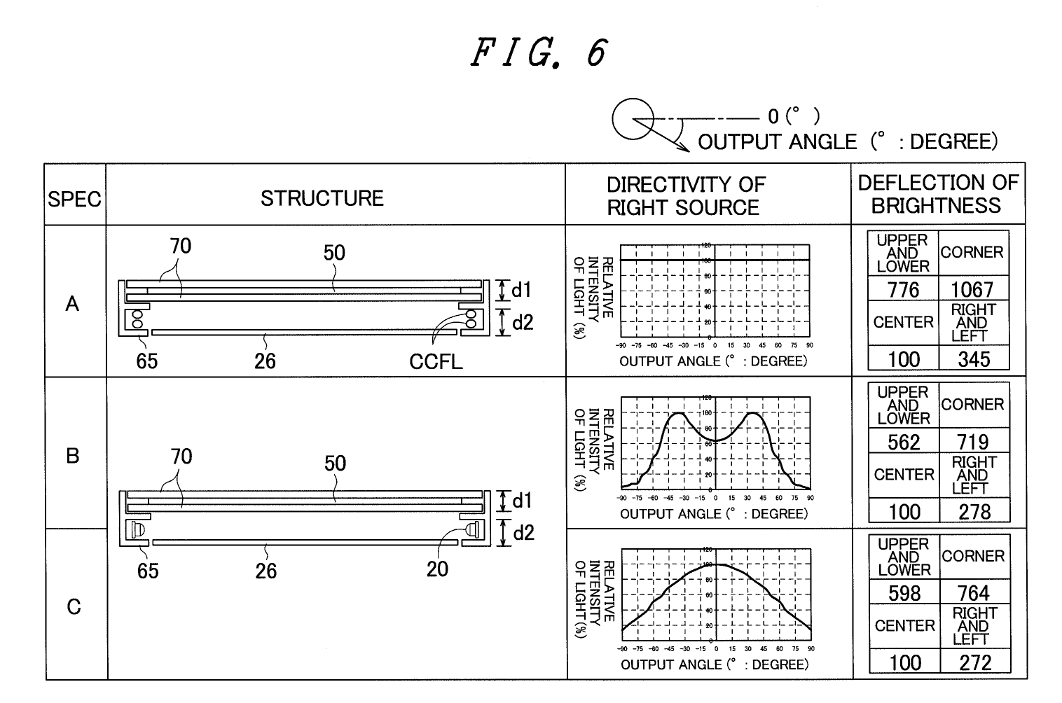

A simulation result related to the contents described above will be described below. FIG. 6 shows the result of evaluating how the luminance distribution changes when a light source is changed in cross section from the lower side to the surface of the liquid crystal shutter 50 in the liquid crystal display device shown in FIG. 1. A specification A is the case where two CCFLs are used by putting one on top of the other as a light source. The CCFL has an L shape and disposed at an inner wall of the lower mold. The directional characteristic of output light from each of the CCFLs is as described in the column of the directional characteristic of light source. This is similar to FIG. 5.

In FIG. 6, a reflective sheet 26 is used in the portion of the specific image in FIG. 1. The surface of the reflective sheet 26 is silver-plated and is a mirror surface. The liquid crystal shutter 50 is sandwiched between upper and lower acrylic plates 70. The acrylic plate 70 has a thickness of 1.5 mm. The acrylic plate 70 serves to protect the liquid crystal molecules 52 in the liquid crystal shutter 50 against ultraviolet ray.

In the lower mold 65, the sidewall mounting the liquid crystal shutter 50 has a height d1 of, for example, 4.8 mm while the sidewall mounting the light source has a height d2 of 10.2 mm. The value of d2 is larger compared with the actual size of the LED 20 or diameter of the CCFL. In the case of the CCFL, the margin in the vertical direction is small because two CCFLs are used. In the case of the LED 20, however, the degree of freedom exists in installation in the vertical direction because one LED 20 is used. As will be described later, the luminance distribution of the acrylic surface or screen can be changed depending on the installation position of the LED.

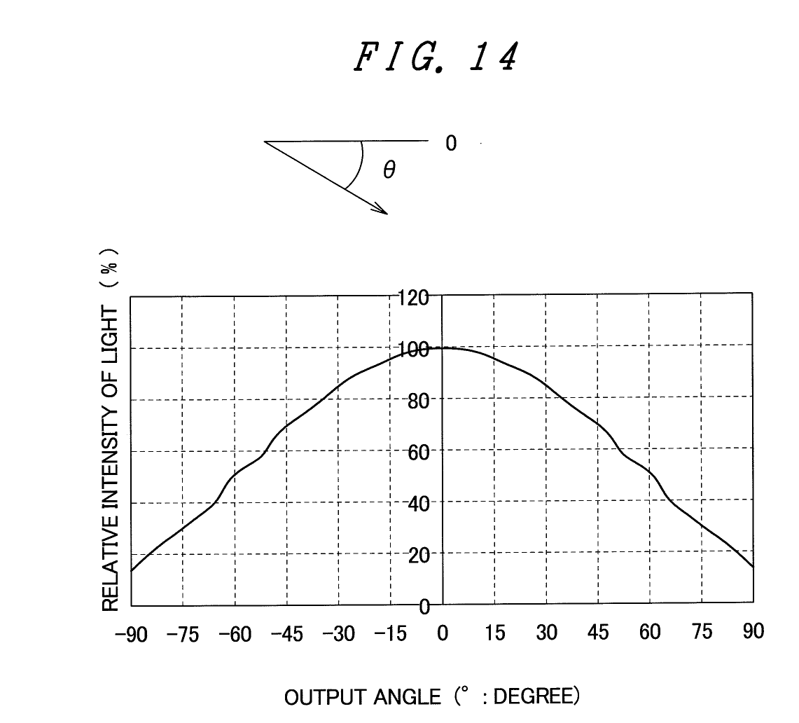

The configuration of a specification B is similar to that of a specification C in an outer appearance. That is, both of the specification B and the specification C use the LED 20. As for the number of the arranged LEDs 20, on the inside of the sidewall of the lower mold 65, 26 LEDs 20 are arranged at a pitch of 10 mm in the long side direction of the screen, and 16 LEDs 20 are arranged at a pitch of 10 mm in the short side direction of the screen. The specification B and the specification C are different from each other in the directional characteristic of the output light from the LED 20. In the specification B, the LED having peaks in two directions is used as shown in FIG. 2. On the other hand, the LED used in the specification C has one peak in the normal line direction of the LED like a usual LED. The luminance directional characteristic of the LED used in the specification C has a similar distribution to that of the LED 20 shown in FIG. 14.

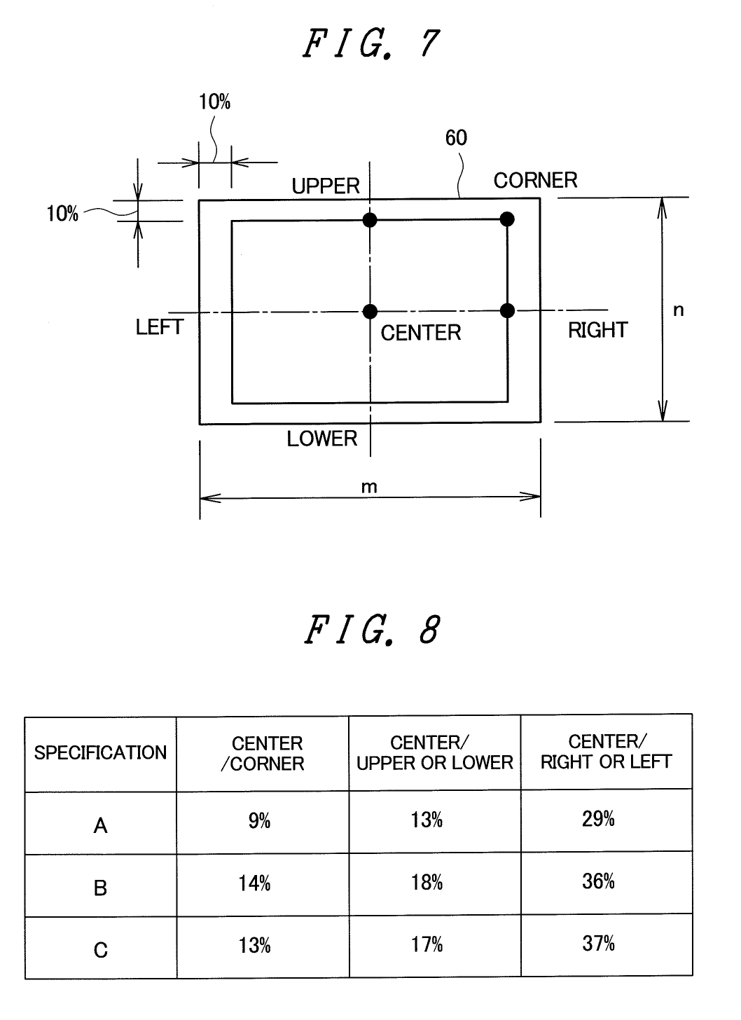

Luminance distribution was evaluated in the configuration of the backlight of the specifications A, B, and C. The luminance was evaluated for the upper surface of the upper acrylic plate shown in FIG. 6. FIG. 7 shows the place where the luminance was measured. In FIG. 7, a major axis m is 265.8 mm, and a minor axis n is 160.8 mm. Measurement points are located on the major axis, minor axis, and at corner portion, each 10% inside the major axis or minor axis from the outermost circumference, and at the center. The point near the minor axis is indicated by “up and down” while the point near the major axis is indicated by “right and left”.

The measurement result is shown in the luminance deviation column which is the rightmost column in the table of FIG. 6. In the luminance deviation, the luminance at the center is expressed as 100, the luminance at the up and down, right and left, and corner is expressed by comparison with that of the center. In the configuration as shown in FIG. 6, the corner is brightest while the center is darkest. Accordingly, it can be said that the luminance distribution is more uniform as the luminance difference between the center and the corner is smaller.

As shown in FIG. 6, the luminance difference above the upper acrylic plate 70 is great when the CCFL is used. The luminance non-uniformity is reduced when the LED 20 is used. Among the cases, the luminance non-uniformity can be mostly reduced when the LED 20 having peaks in two directions is used.

FIG. 8 shows the data shown in FIG. 6 by another expression. That is, FIG. 8 is a table showing the comparison in luminance between the center and the corner, the center and the up and down, and the center and the right and left for the specifications A, B, and C. In the table shown in FIG. 8, it can be said that the luminance non-uniformity is smaller as the numerical value is larger. Also in this table, the numerical value at the center and up and down where the luminance difference is most problematic is greatest in the specification B, that is, when the output light of the LED 20 has peaks in two directions, which shows that the luminance non-uniformity can be reduced.

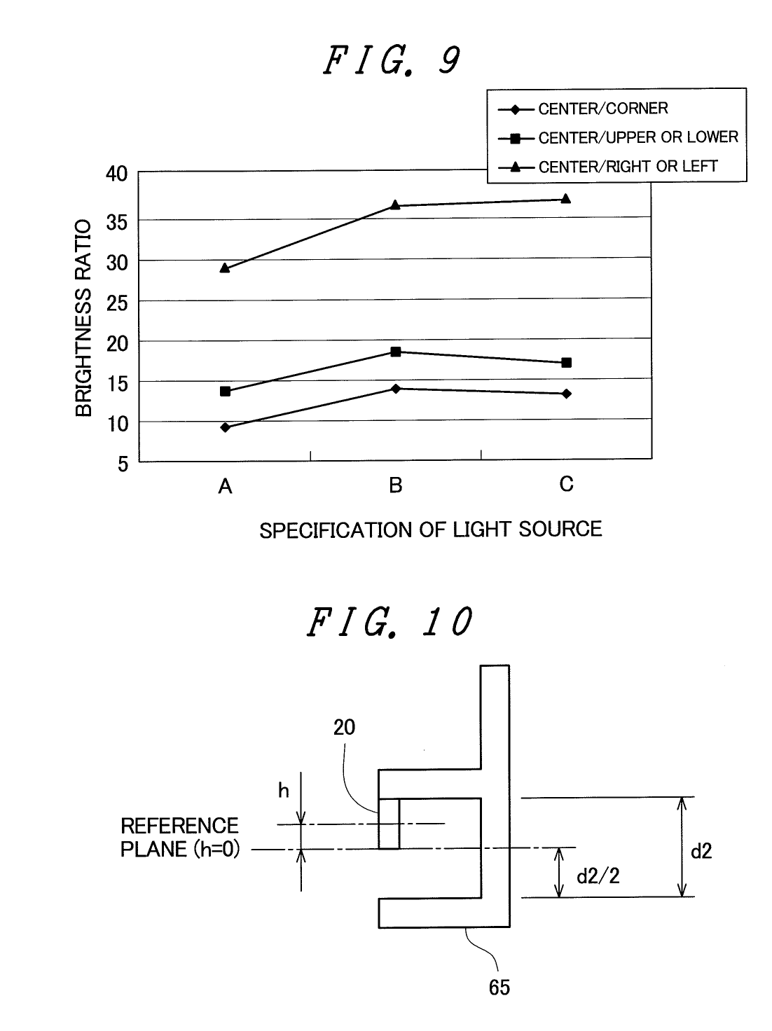

FIG. 9 is a graph obtained by plotting the data in the table of FIG. 8. In FIG. 9, the abscissa axis represents the specification while the ordinate axis represents the luminance ratio. In FIG. 9, the specification B is most excellent in the ratio between the center and the corner and the ratio between the center and the up and down.

FIGS. 10 to 12 show the relationship between the displacement of the LED 20 as a light source in the vertical direction and the luminance non-uniformity in a accommodation part for the LED 20 in the lower mold 65. In FIG. 10, the LED 20 is accommodated in a U-shaped region surrounded by a sidewall having the height d2 and upper wall and lower wall in cross section in the lower mold 65. In FIG. 10, h is the difference between the center of the LED 20 and the center of the sidewall of the lower mold 65 at which the LED 20 is accommodated. As the light source, the specification B in FIG. 6, that is, the LED 20 having the peaks of the output light in two directions is used.

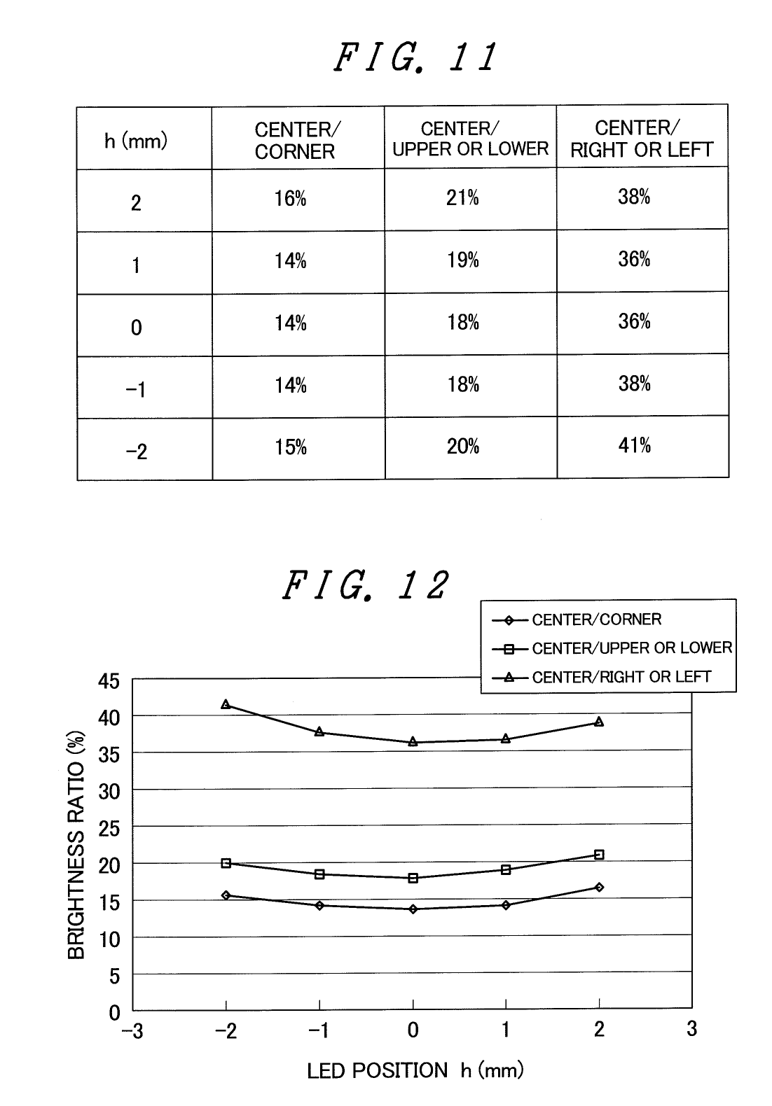

FIG. 11 shows the shift amount between the LED 20 and the center of the sidewall of the lower mold 65 and the comparison of luminance on the upper acrylic plate 70 in FIG. 6. The measurement positions are similar to those of FIG. 7. In FIG. 11, the luminance non-uniformity is smaller as the numerical value is larger. As will be understood from the table in FIG. 11, the luminance non-uniformity above the upper acrylic plate 70 or above the screen is smaller as the center of the LED 20 is shifted from the center of the sidewall formed in the lower mold 65.

FIG. 12 is a graph obtained by plotting the data shown in the table of FIG. 11. In FIG. 12, the abscissa axis represents the shift amount between the center of the LED 20 and the center of the sidewall of the lower mold 65 while the ordinate axis represents the luminance ratio. In FIG. 12, the luminance non-uniformity is smaller as the numerical value is larger. As will be understood from FIG. 12, the luminance non-uniformity is smaller at the place where the position of the LED 20 is 2 mm away from the center of the lower mold 65 according to the luminance ratio between the center and the corner, the center and the up and down, and the center and the right and left. The displacement of the LED 20 in the upward direction or the downward direction does not bring a remarkable difference in the effect of improving the luminance distribution. As can be estimated from FIG. 12, 2 mm or more of the shift amount between the center of the LED 20 and the center of the sidewall formed in the lower mold 65 can provide a remarkable effect.

### Second Embodiment

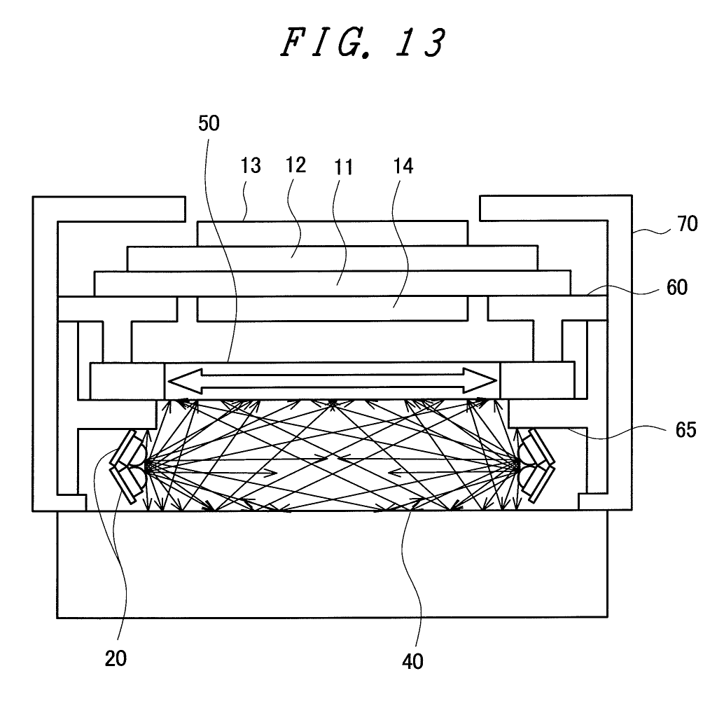

FIG. 13 is a cross sectional view showing a second embodiment of the invention. In FIG. 13, the liquid crystal display panel, the liquid crystal shutter 50, the upper mold 60, and the lower mold 65 are similar to those of the first embodiment in FIG. 1. FIG. 13 differs from FIG. 1 in the LED 20 used as a light source. In the embodiment, two LEDs 20 are used in a pair. The pair of two LEDs 20 are arranged in plural in the vertical direction of the paper surface.

In the first embodiment, the LED 20 which itself has the peaks of the output intensity of light in two directions is used. The LED 20 is available by changing the shape of the mirror surface incorporated in the LED 20, which increases the cost of the LED 20 itself.

In the embodiment, a similar effect to that of the first embodiment is obtained by using the usual LED 20 having the peak of light intensity in the normal line direction of the LED 20 as a light source. FIG. 14 shows an example of the distribution of the light intensity output from the usual LED 20. In FIG. 14, the abscissa axis represents the output angle (θ) with the normal line direction of the LED 20, that is, the direction parallel to the liquid crystal display panel shown in FIG. 13 as zero degree. The ordinate axis of FIG. 14 represents the relative intensity of the light output from the LED 20. As shown in FIG. 14, the LED 20 used in the embodiment has the maximum intensity of the output light from the LED 20 in the normal line direction of the LED 20 and shows the similar distribution to that of the usual LED 20. The LED having the usual directional characteristic is available from the market at low cost.

As shown in FIG. 13, the two LEDs 20 are combined together and used as a light source. That is, in FIG. 13, the upper LED 20 is set at an optimum angle for irradiating the specific image 40. On the other hand, the lower LED 20 is set at an optimum angle as the backlight of the liquid crystal display panel.

The embodiment has a feature that it is easy to set the directional characteristic of a light source at optimum conditions in accordance with the space at the back surface of the liquid crystal shutter 50 because it is sufficient to use the usual LED 20 and change its installation angle. Further, the embodiment has an advantage also in terms of the cost of the LED 20 because it is possible to use not the LED 20 of a special specification but the usual LED 20.

In the above description, the pair of the LEDs 20 have been described as being disposed at both sides of the liquid crystal display device. However, a similar theory is applicable also to the case where the pair of the LEDs 20 are disposed only at one side. When the pair of the LEDs 20 are disposed only at one side, the positions of two peaks in output intensity of the pair of the LEDs 20 may be changed. In this case, the degree of freedom is increased compared with the case of the first embodiment because it is sufficient to change the installation angle of the two LEDs 20.

### Third Embodiment

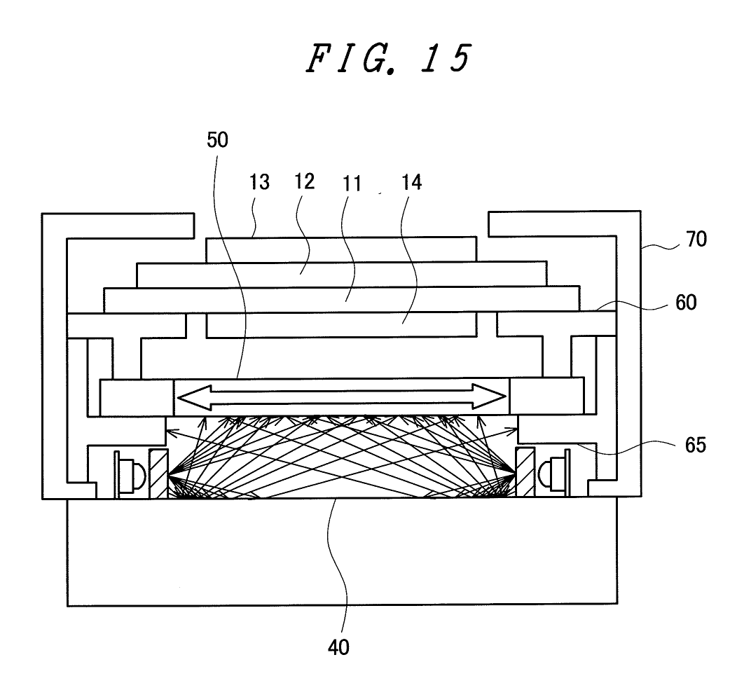

FIG. 15 is a cross sectional view showing a third embodiment of the invention. In FIG. 15, the liquid crystal display panel, the liquid crystal shutter 50, the upper mold 60, and the lower mold 65 and the like are similar to those of the first embodiment in FIG. 1. FIG. 15 differs from FIG. 1 in the LED 20 used as a light source. In the embodiment, the LED 20 having the usual directional characteristic with respect to the output light is used. The LED 20 is arranged in plural in the vertical direction of the paper surface.

In the first embodiment, the LED 20 which itself has the peaks of the output intensity of light in two directions is used. The LED 20 is available by changing the shape of the mirror surface incorporated in the LED 20, which increases the cost of the LED 20 itself.

In the embodiment, a light source having the peaks of output light in two directions is obtained like the first embodiment by using the usual LED 20 having the peak of light intensity in the normal line direction of the LED 20 as a light source and installing a lens on the light output surface of the LED 20. A lens used in the embodiment is not necessarily a precision lens because it is used for the purpose of changing the direction of light. For example, even a lens in which the thickness of plastic is increased at two specific angles can serve the purpose of the embodiment.

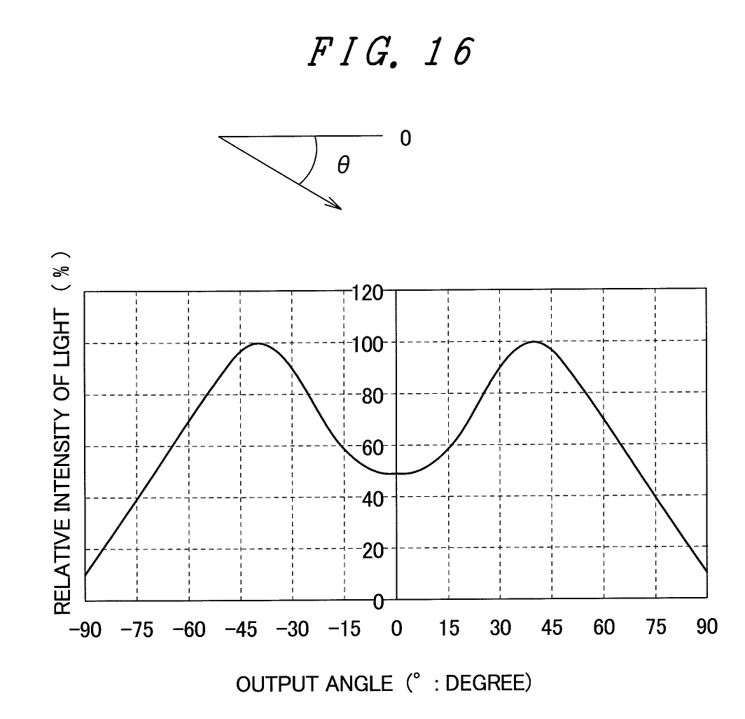

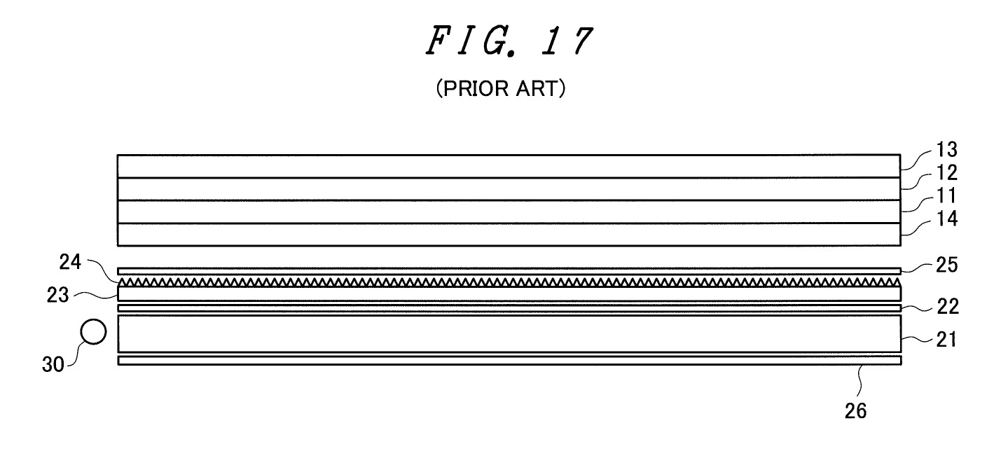

FIG. 16 shows the distribution of the output light from the light source used in the embodiment, that is, the LED 20 and a lens combined together. In FIG. 16, the abscissa axis represents the output angle (θ) with the normal line direction of the LED 20, that is, the direction parallel to the liquid crystal display panel shown in FIG. 15 as zero degree. The ordinate axis of FIG. 16 represents the relative intensity of the light output from the LED 20. As shown in FIG. 16, the intensity of the output light from the light source reaches peaks not in the normal line direction of the LED 20 but at plus 35 degree and minus 35 degree in the light source using the LED 20 used in the embodiment. The peak position of the output light is set similarly to the first embodiment. In the embodiment, the peak position can be freely determined by designing the lens.

The distribution of the relative intensity of the output light in FIG. 16 differs from that of the first embodiment. The distribution of the output light can also be freely changed due to the design of the lens. That is, an optimum light source can be realized in the embodiment by using the usual LED 20 and due to the lens design.

In the above description, the LED 20 has been described as being disposed at both sides of the liquid crystal display device. However, a similar theory is applicable also to the case where the LED 20 is disposed only at one side. When the LED 20 is disposed only at one side, the position of two peaks in output intensity of the LED 20 may be changed. In this case, the degree of freedom is increased compared with the case of the first embodiment because it is sufficient to use the same LED 20 and change the directional characteristic of lens.

What is claimed is:

1. A liquid crystal display device comprising:
a liquid crystal display panel;
a liquid crystal shutter disposed at the back surface of the liquid crystal display panel;
a display object disposed at the back surface of the liquid crystal shutter; and
a light source disposed outside a display surface of the liquid crystal display panel, at the back surface of the liquid crystal shutter, and at the front surface of the display object, wherein
the liquid crystal shutter is in a white-opaque light scattering mode when an image formed on the liquid crystal display panel is displayed,
the liquid crystal shutter is in a light transmitting mode when the display object is displayed, the light source is formed of an LED, and peaks are present in two directions in the distribution of output light from the LED.

2. The liquid crystal display device according to claim 1, wherein the LED is disposed at both sides.

3. A liquid crystal display device comprising:
a liquid crystal display panel;
a liquid crystal shutter disposed at the back surface of the liquid crystal display panel;
a display object disposed at the back surface of the liquid crystal shutter; and
a light source disposed outside a display surface of the liquid crystal display panel, at the back surface of the liquid crystal shutter, and at the front surface of the display object, wherein
the liquid crystal shutter is in a white-opaque light scattering mode when an image formed on the liquid crystal display panel is displayed,
the liquid crystal shutter is in a light transmitting mode when the display object is displayed,
the light source is formed of paired two LEDs, and peaks are present in two directions in output light from the paired two LEDs.

4. The liquid crystal display device according to claim 3, wherein the normal lines of the paired two LEDs are not in parallel with each other.

5. The liquid crystal display device according to claim 3, wherein the paired two LEDs are disposed at both sides.

6. A liquid crystal display device comprising:
a liquid crystal display panel;
a liquid crystal shutter disposed at the back surface of the liquid crystal display panel;
a display object disposed at the back surface of the liquid crystal shutter; and
a light source disposed outside a display surface of the liquid crystal display panel, at the back surface of the liquid crystal shutter, and at the front surface of the display object, wherein
the liquid crystal shutter is in a white-opaque light scattering mode when an image formed on the liquid crystal display panel is displayed,
the liquid crystal shutter is in a light transmitting mode when the display object is displayed,
the light source is formed of an LED, a lens is disposed on an output surface of light from the LED, and peaks are present in two directions in the distribution of output light from the lens.

7. The liquid crystal display device according to claim 6, wherein the LED is disposed at both sides.

8. A liquid crystal display device comprising:
a liquid crystal display panel;
a liquid crystal shutter disposed at the back surface of the liquid crystal display panel;
a display object disposed at the back surface of the liquid crystal shutter; and
a light source disposed outside a display surface of the liquid crystal display panel, at the back surface of the liquid crystal shutter, and at the front surface of the display object, wherein
the liquid crystal shutter is in a white-opaque light scattering mode when an image formed on the liquid crystal display panel is displayed,
the liquid crystal shutter is in a light transmitting mode when the display object is displayed,
the light source is formed of an LED, the LED is accommodated in a U-shaped region surrounded by a sidewall in a direction parallel to the normal line of the liquid crystal display panel and upper and lower walls in a direction substantially orthogonal to the sidewall in cross section, the center of the LED does not coincide with the center of the sidewall, and
peaks are present in two directions in the distribution of output light from the LED.

9. The liquid crystal display device according to claim 8, wherein the shift amount between the center of the LED and the center of the sidewall is 2 mm or more.
